(19) United States
(12) Patent Application Publication
(10) Pub. No.: US 2014/0204785 A1
(43) Pub. Date: Jul. 24, 2014

(54) COMMUNICATION APPARATUS AND METHOD OF USING MASSIVE MULTIPLE INPUT MULTIPLE OUTPUT

(71) Applicant: ELECTRONICS AND TELECOMMUNICATIONS RESEARCH INSTITUTE, Daejeon (KR)

(72) Inventors: Kwi Hoon KIM, Daejeon (KR); Ho Kyom KIM, Daejeon (KR); Il Min KIM, Suwon (KR); Woong Shik YOU, Sejong (KR); O Hyung KWON, Daejeon (KR)

(73) Assignee: ELECTRONICS AND TELECOMMUNICATIONS RESEARCH INSTITUTE, Daejeon (KR)

(21) Appl. No.: 14/160,897

(22) Filed: Jan. 22, 2014

(30) Foreign Application Priority Data
Jan. 21, 2013 (KR) 10-2013-0006538

(51) Int. Cl. H04W 24/08; H04W 72/08

(52) U.S. Cl. CPC H04W 24/08; H04W 72/085
USPC 370/252

(57) ABSTRACT

A communication apparatus and method using a massive multiple input multiple output (MIMO) is disclosed, the method including measuring a transmission capacity between terminals disposed in a cell and a base station when a number of terminals disposed in the cell of the base station is greater than a number of terminals to be supported by the base station, and selecting at least one terminal for maximizing a network capacity from among terminals disposed in the cell based on the transmission capacity and the number of terminals to be supported by the base station.

### CROSS-REFERENCE TO RELATED APPLICATION

This application claims the priority benefit of Korean Patent Application No. 10-2013-0006538, filed on Jan. 21, 2013, in the Korean Intellectual Property Office, the disclosure of which is incorporated herein by reference.

### BACKGROUND

1. Field of the Invention

The present invention relates to a communication apparatus and method using a massive multiple input multiple output (MIMO), and more particularly, to a communication apparatus and method for efficiently transmitting massive data in a communication system using a massive MIMO.

2. Description of the Related Art

Multiple input multiple output (MIMO) technology refers to technology for transreceiving data using a plurality of antennas, and has an advantage in that an amount of data transmitted may increase without expanding a wireless bandwidth.

Conventional MIMO technology is associated with an operation in which a number of transmission antennas is limited to less than a predetermined number, however, a higher data transmission rate may be required as wireless communication increases. Massive MIMO technology developed to address an issue of such an increase may transmit data under less transmission power conditions using a great number of small antennas, and have a lower impact on an overall performance, despite an occurrence of a malfunction in a portion of the great number of small antennas.

However, the massive MIMO technology may be restricted in that obtaining precise channel information is not possible due to reuse of a frequency of a cellular system. More particularly, in the cellular system, a terminal disposed in one cell may transmit a pilot signal using a frequency identical to a frequency of a terminal disposed in another cell of a base station. In this instance, the base station may not obtain precise channel information of the terminal because the pilot signal transmitted by the terminal disposed in the one cell functions as interference to the signal transmitted by the terminal disposed in the other cell of the base station.

Accordingly, there is a desire for a method of transmitting a large amount of data through minimizing interference of a terminal.

### SUMMARY

An aspect of the present invention provides an apparatus and method that selects a number of terminals to be supported by a base station based on a transmission capacity of the terminals, and transmits a maximum amount of data to terminals capable of transmitting a maximum data capacity.

Another aspect of the present invention also provides an apparatus and method that identifies a pilot assigned to a terminal disposed, by a neighboring base station, in a cell of the neighboring base station, and identifies pilots for transmitting maximum data to the terminal in the cell of the base station when a number of terminals disposed in the cell of the base station is less than a number of terminals to be supported by the base station.

Still another aspect of the present invention also provides an apparatus and method that assigns a pilot selected based on a number of users in a cell of a base station to minimize interference in a cell of a neighboring base station, and identifies a pilot capable of transmitting, from a plurality of terminals, maximum data.

Yet another aspect of the present invention also provides an apparatus and method that selects a maximum number of pilot symbols based on a number of terminals disposed in a cell, and identifies an optimum number of pilot symbols based on the number of terminals when the number of terminals disposed in the cell is less than a number of terminals to be supported by the base station.

Further another aspect of the present invention also provides an apparatus and method that limits an object for calculating a network capacity to a base station, or a set of pilots using identical pilots, and reduces an amount of calculation required for calculating the network capacity.

According to an aspect of the present invention, there is provided a communication method conducted by a communication apparatus of a base station, the communication method including measuring a transmission capacity between terminals disposed in a cell and a base station when a number of the terminals disposed in the cell of the base station is greater than a number of terminals to be supported by the base station, and selecting at least one terminal of which a capacity of a network is maximized, from among the terminals disposed in the cell, based on the transmission capacity and the number of terminals to be supported by the base station.

The measuring of the transmission capacity may include measuring a channel between the base station and the terminal, and calculating a signal-to-interference ratio (SIR) of the channel, and predicting the transmission capacity between the terminal and the base station, using the SIR of the channel.

According to an aspect of the present invention, there is provided a communication method conducted by a communication apparatus of a base station, the communication method including identifying a pilot used by a neighboring base station when a number of terminals disposed in a cell of a base station is less than a number of terminals to be supported by the base station, and selecting a pilot differing from the pilot used by the neighboring base station from among pilots of the base station, and assigning the selected pilot to the terminals disposed in the cell of the base station.

According to an aspect of the present invention, there is provided a communication method conducted by a communication apparatus of a base station, the communication method including identifying a pilot assigned to an interfering terminal which interferes with a terminal disposed in a cell of a base station, from among terminals disposed in a cell of a neighboring base station, and assigning a pilot to a terminal disposed within a predetermined distance from the interfering terminal, from among the terminals disposed in the cell of the base station based on the identified pilot.

The assigning of the pilot may include assigning a pilot differing from the pilot identified, from among pilots of the base stations, to the terminal disposed within the predetermined distance from the interfering terminal.

According to an aspect of the present invention, there is provided a communication method conducted by a communication apparatus of a base station, the communication method including selecting a maximum number of pilot symbols of a base station, based on a number of terminals disposed in a cell of the base station when a number of the terminals disposed in the cell of the base station is less than a number of terminals to be supported by the base station.

The communication method may further include using a number of symbols, subsequent to excluding the maximum number of pilot symbols of the base station from a total number of symbols of the base station.

According to an aspect of the present invention, there is provided a communication apparatus, including a capacity measurer to measure a capacity of a network system, based on information associated with a terminal connected to a base station of the network system, and a pilot to be assigned, by the base station, to the terminal, and a terminal selector to select a terminal for transmitting data, by the base station, to maximize the capacity of the network system.

The capacity measurer may calculate the capacity of the network system of the base station, based on the information associated with the terminal connected to the base station of the network system and the pilot to be assigned, by the base station, to the terminal, and the terminal selector may select a terminal to which the data is transmitted by the base station to maximize the capacity of the network system of the base station.

The terminal selector may include a transmission capacity measurer to measure a transmission capacity between terminals disposed in a cell and a base station when a number of the terminals disposed in the cell of the base station is greater than a number of terminals to be supported by the base station, and an optimum terminal selector to select at least one terminal of which a capacity of a network system is maximized, from among the terminals disposed in the cell, based on the transmission capacity and the number of terminals to be supported by the base station.

According to an aspect of the present invention, there is provided a communication apparatus, including a capacity measurer to measure a capacity of a network system based on information associated with a terminal connected to a base station of the network system and a pilot to be assigned, by the base station, to the terminal, and a pilot selector to select the pilot to be assigned, by the base station, to the terminal, to maximize the capacity of the network system.

The pilot selector may include a pilot identifier to identify a pilot used by a neighboring base station when a number of terminals disposed in a cell of the base station is less than a number of terminals to be supported by the base station, and an optimum pilot selector to select a pilot differing from the pilot used by the neighboring base station from among pilots of the base station, and maximize the capacity of the network system.

According to an aspect of the present invention, there is provided a communication apparatus, including a capacity measurer to measure a capacity of a network system based on information associated with a terminal connected to a base station of the network system and a pilot to be assigned, by the base station, to the terminal, and a pilot assigner to assign a pilot to a terminal to maximize the capacity of the network system.

The pilot assigner may include a pilot identifier to identify a pilot assigned to an interfering terminal which interferes with a terminal disposed in a cell of a base station, from among terminals disposed in a cell of a neighboring base station, and an optimum pilot assigner to assign a pilot to a terminal disposed within a predetermined distance from the interfering terminal, from among the terminals disposed in the cell of the base station, based on the identified pilot, and maximize the capacity of the network system.

According to an aspect of the present invention, there is provided a communication apparatus, including a pilot symbol number assigner to select a maximum number of pilot symbols of a base station, based on a number of terminals disposed in a cell of the base station when the number of the terminals disposed in the cell of the base station is less than a number of terminals to be supported by the base station.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a communication system including a communication apparatus according to an embodiment of the present invention;

FIG. 2 is a diagram illustrating a communication apparatus according to an embodiment of the present invention;

FIG. 3 is a diagram illustrating a terminal selector according to an embodiment of the present invention;

FIG. 4 is a diagram illustrating a process of selecting a terminal according to an embodiment of the present invention;

FIG. 5 is a diagram illustrating a pilot selector according to an embodiment of the present invention;

FIG. 6 is a diagram illustrating a process of selecting a pilot according to an embodiment of the present invention;

FIG. 7 is a diagram illustrating a pilot assigner according to an embodiment of the present invention;

FIG. 8 is a diagram illustrating a process of assigning a pilot according to an embodiment of the present invention;

FIG. 9 is a diagram illustrating a process of assigning a number of pilot symbols according to an embodiment of the present invention;

FIG. 10 is a flowchart illustrating a method of operating a base station according to an embodiment of the present invention;

FIG. 11 is a flowchart illustrating a method of selecting a terminal according to an embodiment of the present invention;

FIG. 12 is a flowchart illustrating a method of selecting a pilot according to an embodiment of the present invention; and

FIG. 13 is a flowchart illustrating a method of assigning a pilot according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

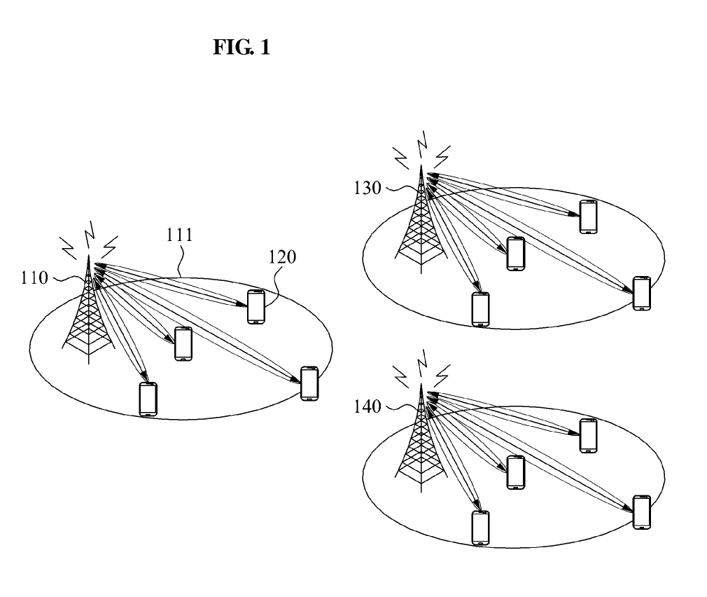

FIG. 1 is a diagram illustrating a communication system including a communication apparatus according to an embodiment of the present invention.

The communication system including the communication apparatus may refer to a communication system using massive multiple input multiple output (MIMO) technology. In this instance, the communication system may refer to a multiple cell network system in which a plurality of base stations forms a plurality of cells, and communicates with terminals disposed in the plurality of cells of the plurality of base stations as shown in FIG. 1.

More particularly, in the communication system including the communication apparatus, a base station 110 including a plurality of antennas may transmit data to a plurality of terminals 120 disposed in a cell 111 of the base station 110 at ultra high speed through communicating using differing antennas as shown in FIG. 1. In this example, the base station 110 may use a limitless number of antennas in theory, however, according to an exemplary embodiment, the base station 110 may use approximately 200 antennas.

The communication system may calculate a network capacity of the communication system based on information associated with a terminal and a pilot to be assigned, by base stations included in the communication system, to a terminal disposed in respective cells, and control the base station 110 to maximize the capacity of a network system.

In this example, the communication system may communicate through selecting a number of terminals to be supported by the base station 110 based on a transmission capacity of the plurality of terminals 120 when a number of the plurality of terminals 120 disposed in the cell 111 is greater than the number of terminals to be supported by the base station 110.

For example, when a number of antennas of the base station 110 is 200, and the number of the plurality of terminals 120 disposed in the cell 111 is 220, the base station 110 may communicate with the 200 terminals 120 because the base station 110 communicates through matching the 200 antennas to the plurality of terminals 120 on a one to one basis. Accordingly, the communication apparatus may maximize the capacity of the network system through enabling the base station 110 to select the 200 terminals 120 based on the transmission capacity of the 200 terminals 120, and communicate with the selected 200 terminals 120.

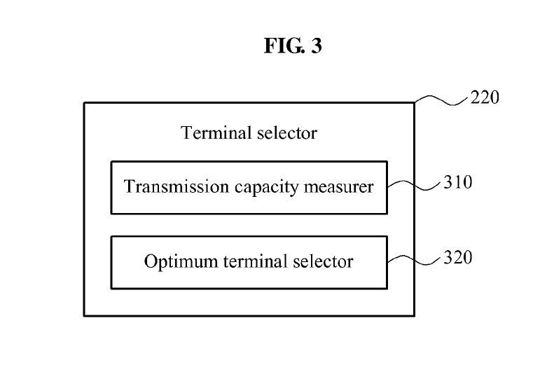

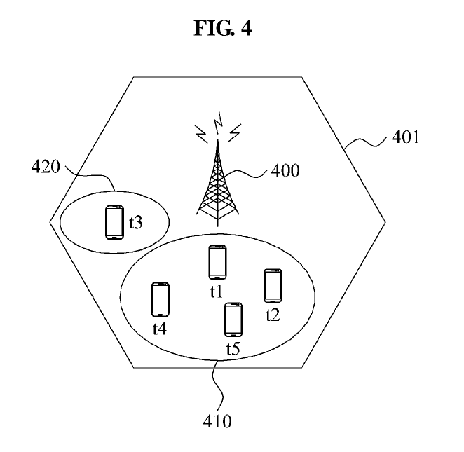

Detailed configurations and operations in which the base station 110 selects the plurality of terminals 120 based on the communication apparatus will be described with reference to FIGS. 3 and 4.

Also, the communication apparatus may identify a pilot assigned, by a neighboring base station 130 and a base station 140, to a terminal disposed in cells of the neighboring base station 130 and the base station 140, and based on a result of the identification, select a pilot to be assigned to the plurality of terminals 120 when the number of the plurality of terminals 120 disposed in the cell 111 is less than the number of the plurality of terminals 120 to be supported by the base station 110.

By way of example, a single terminal may be disposed in each cell of the base station 110, the base station 130, and the base station 140, and the base stations 110, 130, and 140 may include four antennas capable of using a pilot P1, a pilot P2, a pilot P3, and a pilot P4, respectively. Also, the base station 130 may assign the pilot P2 to the terminal disposed in the cell of the base station 130, and the base station 140 may assign the pilot P4 to the terminal disposed in the cell of the base station 140.

In this instance, when the base station 110 assigns the pilot P2 or the pilot P4 to the plurality of terminals 120, interference may occur with the terminal of the base station 130 or the base station 140. Also, pilots may be assigned to the plurality of terminals 120, absent use of the pilot P2 and the pilot P4 because a number of pilots available to be assigned by the base station 110 is four, which is greater than the number of the plurality of terminals 120. Accordingly, the communication apparatus may enable the base station 110 to assign the pilot P1 or the pilot P3 to the plurality of terminals 120, and enable the plurality of terminals 120 not to interfere with the base station 130 or the base station 140 to maximize the capacity of the network system.

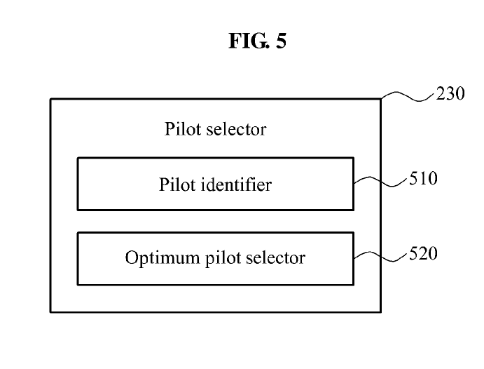

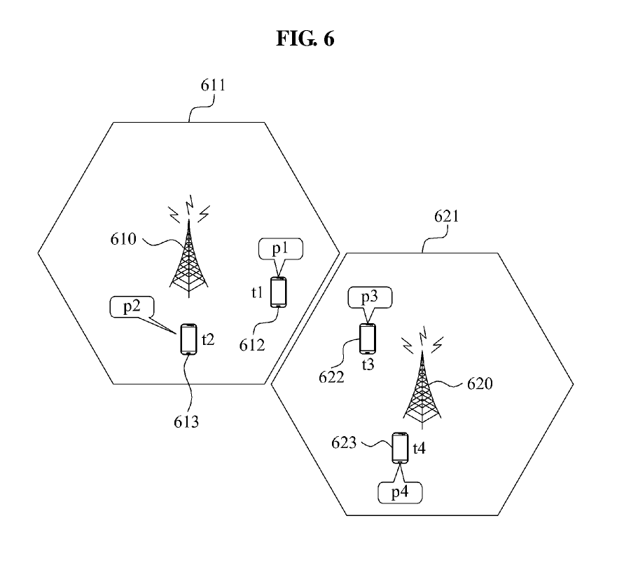

Detailed configurations and operations in which the base station 110 selects a pilot based on the communication apparatus will be described with reference to FIGS. 5 and 6.

Additionally, the communication apparatus may assign a pilot not to be interfered with to the plurality of terminals 120 likely to experience interference due to the neighboring base station 130, based on the pilot assigned to the terminal disposed in the cell of the neighboring base station 130.

For example, a terminal disposed in an area adjacent to the base station 110 in the cell of the base station 130 may be assigned with the pilot P2 from the base station 130. Here, when the base station 110 assigns the pilot P2 to the plurality of terminals 120 adjacent to the cell of the base station 130, the plurality of terminals 120 may experience interference due to the base station 130.

Accordingly, the communication apparatus may enable the base station 110 to assign a pilot differing from the pilot P2 to the plurality of terminals 120 adjacent to the cell of the base station 130 and assign the pilot P2 to the plurality of terminals 120 disposed in an area as remote as possible from the cell of the base station 130 and thus, enable the plurality of terminals not to experience interference due to the base station 130 so as to maximize the capacity of the network system.

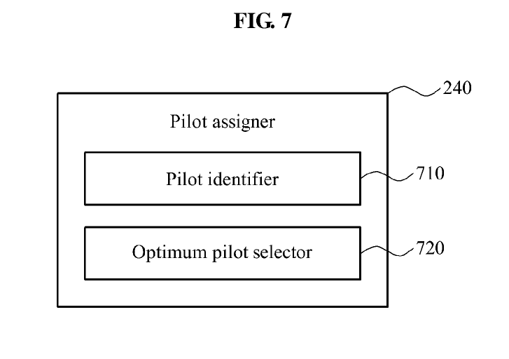

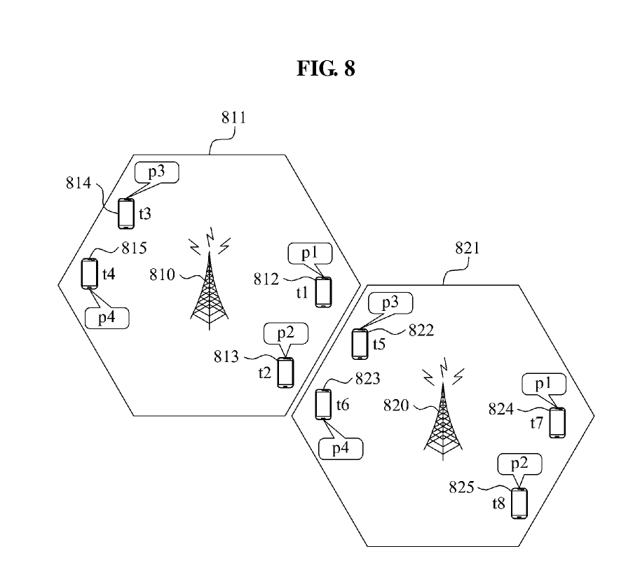

Detailed configurations and operations in which the base station 110 assigns a pilot based on the communication apparatus will be described with reference to FIGS. 7 and 8.

Further, the communication apparatus may select a maximum number of pilot symbols based on the number of the plurality of terminals 120 disposed in the cell 111, and use a number of symbols remaining subsequent to excluding the maximum number of pilot symbols of the base station 110 from a total number of symbols when the number of the plurality of terminals 120 disposed in the cell 111 is less than the number of terminals 120 to be supported by the base station 110. In this example, when a number of symbols to be used as data symbols from among the total number of symbols increases, the capacity of the network system may increase.

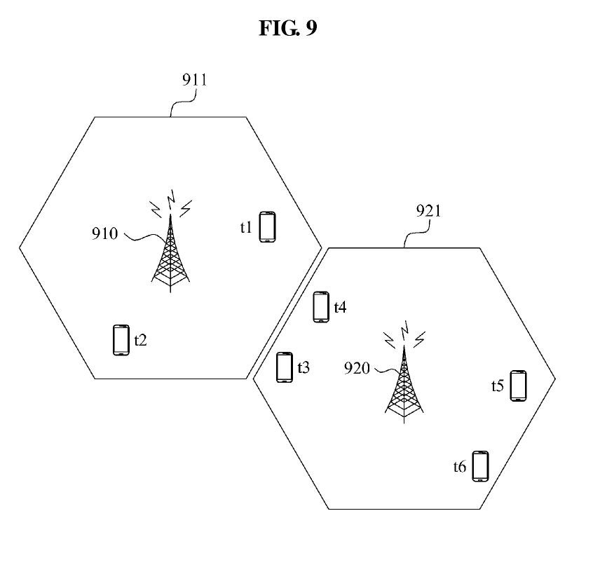

Detailed configurations and operations in which the base station 110 assigns a number of pilot symbols based on the communication apparatus will be described with reference to FIG. 9.

The communication apparatus may be included in the base station 110 for collaborative communication through receiving information associated with a terminal and a pilot to be assigned to a terminal disposed in respective cells of the base station 130 and the base station 140, from the base station 130 and the base station 140, and transmitting information associated with a pilot to be assigned to the plurality of terminals 120 and information associated with the plurality of terminals 120 to the base station 130 and the base station 140. In this instance, the base station 110 may communicate based on control of the communication apparatus.

Also, the communication apparatus may be included in an external server or a controller for controlling operations of the base station 110, the base station 130, and the base station 140.

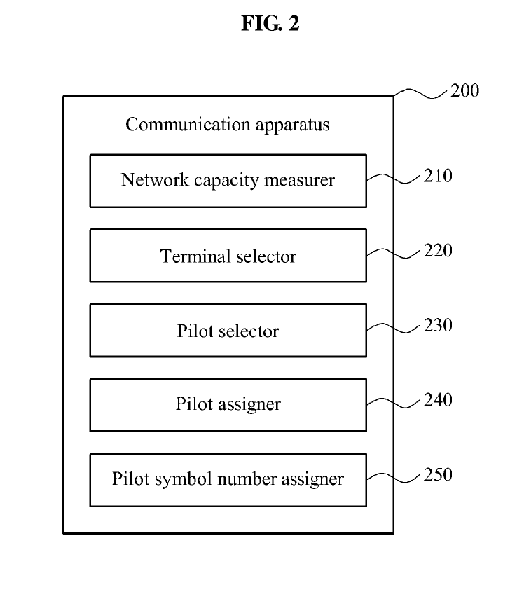

FIG. 2 is a diagram illustrating a communication apparatus 200 according to an embodiment of the present invention.

Referring to FIG. 2, the communication apparatus 200 may include a network capacity measurer 210, a terminal selector 220, a pilot selector 230, a pilot assigner 240, and a pilot symbol number assigner 250.

The network capacity measurer 210 may calculate a network capacity of a communication system, using information associated with a terminal and a pilot selected by base stations included in the communication system and information associated with a pilot assigned, by the base stations, to the terminal. For example, when the communication apparatus 200 is included in the base station 110, the communication apparatus 200 may [symbol] receive the aforementioned information from other base stations included in the communication system. Also, when the communication apparatus 200 is included in the external server, the communication apparatus 200 may receive the aforementioned information from all base stations included in the communication system.

For example, the network capacity measurer 210 may calculate the network capacity of the communication system using Equation 1.

$${C}_{network} ( {Ψ}_{l} , {Φ}_{l} , {π}_{l} ) = {\sum }_{p ∈ \text{?}} {μlog}_{2} ( 1 + \frac{{β}_{\text{?}}^{2}}{{\sum }_{\text{?}} {β}_{\text{?}}^{2}} ) + {\sum }_{\text{?}} {\sum }_{\text{?}} {μlog}_{2} ( 1 + \frac{{β}_{\text{?}}^{2}}{{β}_{\text{?}}^{2} + {\sum }_{\text{?}} {β}_{\text{?}}^{2}} ) + {\sum }_{\text{?}} {\sum }_{\text{?}} {μlog}_{2} ( 1 + \frac{{β}_{\text{?}}^{2}}{{\sum }_{\text{?}} {β}_{\text{?}}^{2}} ) \\ \text{?} \text{indicates text missing or illegible when filed} \qquad [ Equation 1 ]$$

Here, variables included in Equation 1 may be defined based on Equation 2.

$$\text{?} the set of terminals who exist in the i \text{-} th cell with \vert \text{?} \vert = {U}_{l} , l = 1 , 2 , … , L . \\ \text{?} the index set of selected terminals in the i \text{-} th cell ( out of all {U}_{l} terminals in \text{?} ) with \vert \text{?} \vert = min ( K , \text{?} ) \\ \text{?} ( k ) the k \text{-} th element of \text{?} representing the k \text{-} th terminal in the set \text{?} \\ \text{?} = \{ \text{?} \} \\ \text{?} the set of selected pilots in the i \text{-} th cell ( out of all K pilots ) with \vert \text{?} \vert = min ( K , \text{?} ) \\ Φ = \{ 1 , 2 , … , K \} \text{?} = \{ \text{?} \} \\ \text{?} the index of terminal in \text{?} whom pilot p is assigned to When p ∈ \text{?} \\ Let p denote the p \text{-} th pilot of Φ . \\ \text{?} the \text{?} element of \text{?} which is the particular terminal in \text{?} whom pilot p is assigned to \\ \text{?} = 0 and \text{?} = 0 pilot p is not assigned to any terminal in cell l \\ \text{?} = \text{?} the set of pilot assignment for all K pilots in cell l \\ \text{?} = \text{?} \\ \text{?} the set of all basic stations that are using the p \text{-} th pilot \\ \text{?} = \text{?} for any p ∈ Φ \\ \text{?} can be uniquely determined if \text{?} is given , and vice versa \\ \text{?} \text{indicates text missing or illegible when filed} \qquad [ Equation 2 ]$$

The terminal selector 220 may select a number of terminals to be supported by the base station 110 based on a transmission capacity of the plurality of terminals 120 when the number of the plurality of terminals 120 disposed in the cell 111 is greater than the number of terminals to be supported by the base station 110. In this example, the terminals selected by the terminal selector 220 may be represented as a variable Ψₗ.

Detailed configurations and operations in which the terminal selector 220 selects the plurality of terminals 120 will be described with reference to FIGS. 3 and 4.

The pilot selector 230 may identify the pilot assigned to the terminal disposed in the respective cells of the neighboring base station 130 and the base station 140, and based on a result of the identification, select the pilot to be assigned to the plurality of terminals 120 when the number of the plurality of terminals 120 disposed in the cell 111 is less than the number of the plurality of terminals 120 to be supported by the base station 110. In this example, the pilot selected by the pilot selector 230 may be represented as the variable Φₗ.

Detailed configurations and operations in which the pilot selector 230 selects the pilot will be described with reference to FIGS. 5 and 6.

The pilot assigner 240 may assign a pilot not to be interfered with to the plurality of terminals 120 likely to experience interference due to neighboring base stations, based on the pilot assigned to the terminal disposed in the respective cells of the neighboring base stations. In this instance, terminals assigned with a pilot P by the pilot assigner 240 may be represented as a variable πₗ(p).

Detailed configurations and operations in which the pilot assigner 240 assigns the pilot will be described with reference to FIGS. 7 and 8.

The pilot symbol number assigner 250 may assign a maximum number of pilot symbols based on a number of terminals disposed in a cell 911, and use a number of remaining symbols as data symbols to maximize a network capacity of the cell 911 and a personal processing capacity.

More particularly, the pilot symbol number assigner 250 may select a maximum number of pilot symbols of the base station 110 based on a number of the plurality of terminals 120 disposed in the cell 111, and use a number of symbols subsequent to excluding the maximum number of pilot symbols of the base station 110 from a total number of symbols of the base station 110 as a number of data symbols when the number of the plurality of terminals 120 disposed in the cell 111 is less than the number of the plurality of terminals 120 to be supported by the base station 110.

Detailed configurations and operations in which the pilot symbol number assigner 260 assigns a number of pilot symbols will be described with reference to FIG. 9.

The terminal selector 220, the pilot selector 230, and the pilot assigner 240 of the communication apparatus 200 may select Ψₗ^{opt}, Φₗ^{opt}, and πₗ^{opt}, for example, Ψₗ, φₗ, and πₗ(p), for maximizing a total of a network capacity of the communication system, respectively, using Equation 3.

$$( {Ψ}_{l}^{opt} , {Φ}_{l}^{opt} , {π}_{l}^{opt} ) = arg {max}_{( {Ψ}_{l} , {Φ}_{l} , {π}_{l} )} {C}_{network} ( {Ψ}_{l} , {Φ}_{l} , {π}_{l} ) \qquad [ Equation 3 ]$$

In Equation 3, the communication apparatus 200 may operate another configuration based on a difference between the number of the plurality of terminals 120 disposed in the cell 111 and the number of the plurality of terminals 120 to be supported by the base station 110.

For example, the terminal selector 220 and the pilot assigner 240 may operate, and the pilot selector 230 and the pilot symbol number assigner 250 may not operate when the number of the plurality of terminals 120 disposed in the cell 111 is greater than the number of the plurality of terminals 120 to be supported by the base station 110.

Accordingly, the communication apparatus 200 may select Ψₗ^{opt} and πₗ^{opt} for maximizing the total of the network capacity of the communication system using Equation 4 in which the variable Φₗ is set to be a constant.

$$( {Ψ}_{l}^{opt , O} , {π}_{l}^{opt , O} ) = arg {max}_{( {Ψ}_{l} , {π}_{l} )} {C}_{network}^{O} ( {Ψ}_{l} , {π}_{l} ) \qquad [ Equation 4 ]$$

When the communication apparatus 200 is included in the base station 110, and the network capacity measurer 210 calculates Ψₗ^{opt} and πₗ^{opt} based on Equation 4, an amount of calculation performed may be substantial because information associated with all the base stations included in the communication system may need to be used. Also, when a plurality of base stations calculates Ψₗ^{opt} and πₗ^{opt} for maximizing a network capacity of respective cells of the plurality of base stations, a total network capacity of the communication system may be maximized.

Accordingly, the network capacity measurer 210 may calculate Ψₗ^{opt} and πₗ^{opt} for maximizing the network capacity of the cell of the base station 110 based on Equation 5, and thereby reduce an amount of calculation required for selecting Ψₗ^{opt} and πₗ^{opt} for maximizing the total of the network capacity of the communication system.

$$( {Ψ}_{l}^{opt , O} , {π}_{l}^{opt , O} ) = arg {max}_{( {Ψ}_{l} , {π}_{l} )} {C}_{l}^{O} ( {Ψ}_{l} , {π}_{l} ) \\ where \\ {C}_{l}^{O} ( {Ψ}_{l} , {π}_{l} ) = {\sum }_{p ∈ Φ} {μlog}_{2} ( 1 + \frac{{β}_{l , {Ψ}_{l} ( {π}_{l} ( p ) )}^{2}}{{\sum }_{j ∈ {B}_{( - 1 )}^{p}} {β}_{j , {Ψ}_{l} ( {π}_{l} ( p ) )}^{2}} ) \qquad [ Equation 5 ]$$

Also, a plurality of base stations included in the communication system may include a base station of which a type and a number of pilots available to be assigned to a terminal or a type and a number of pilots assigned to a terminal are identical to a type and a number of pilots available to be assigned to a terminal or a type and a number of pilots assigned to a terminal of another base station. In this example, the network capacity measurer 210 may create a set of pilots through grouping at least one other base station of which a type and a number of pilots available to be assigned to a terminal is identical to a type and a number of pilots available to be assigned to a terminal of the base station 110, or at least one other base station of which a type and a number of pilots assigned to a terminal is identical to the type and the number of pilots assigned to the terminal of the base station 110. Additionally, the network capacity measurer 210 may calculate a network capacity of a cell of the base station to 110, and transmit the calculated network capacity of the cell to the base station included in the set of pilots. Further, the network capacity measurer 210 may receive the network capacity of the cell from the base station included in the set of pilots, and set the received network capacity of the cell to be the network capacity of the cell of the base station 110. For example, the network capacity measurer 210 may calculate Ψₗ^{opt} and πₗ^{opt} for maximizing the network capacity of the cell of the base station included in the set of pilots using Equation 6.

$$( {Ψ}_{l}^{opt , O} , {π}_{l}^{opt , O} ) = arg {max}_{( {Ψ}_{l} , {π}_{l} ) ∈ {Ω}_{l}} {C}_{l}^{O} ( {Ψ}_{l} , {π}_{l} ) \qquad [ Equation 6 ]$$

In particular, a number of base stations of which a network capacity is to be calculated may be reduced by calculating the network capacity of the cell of the base station included in the set of pilots once, and calculating the calculated network capacity of the cell to be a common network capacity of the base stations included in the set of pilots. Also, as the number of base stations of which the network capacity is required to be calculated decreases, an amount of calculation required for selecting Ψₗ^{opt} and πₗ^{opt} for maximizing the total network capacity of the communication system may decrease.

When the number of the plurality of terminals 120 disposed in the cell 111 is less than the number of the plurality of terminals 120 to be supported by the base station 110, the pilot selector 230 and the pilot assigner 240 may operate while the terminal selector 220 may not operate.

Accordingly, the communication apparatus 200 may select Φₗ^{opt} and πₗ^{opt} for maximizing the total of the network capacity of the communication system using Equation 7 in which the variable Ψₗ is set to be the constant.

$$( {Ψ}_{l}^{opt , U} , {π}_{l}^{opt , U} ) = arg {max}_{( {Ψ}_{l} , {π}_{l} )} {C}_{network}^{U} ( {Ψ}_{l} , {π}_{l} ) \qquad [ Equation 7 ]$$

When the communication apparatus 200 is included in the base station 110, and when the network capacity measurer 210 calculates Φₗ^{opt} and πₗ^{opt} based on Equation 7, an amount of calculation performed may be great because using information of all the base stations included in the communication system may be necessary. In addition, when the plurality of base stations calculates Φₗ^{opt} and πₗ^{opt} for maximizing the network capacity of the cell of the base station, the total network capacity of the communication system may be maximized.

As a result, the network capacity measurer 210 may reduce the amount of calculation required for selecting Ψₗ^{opt} and πₗ^{opt} for maximizing the total of the network capacity of the communication system through calculating Ψₗ^{opt} and πₗ^{opt} for maximizing a total network capacity of the cell of the base station 110 using Equation 8.

$$( {Φ}_{l}^{opt , U} , {π}_{l}^{opt , U} ) = arg {max}_{( {Ψ}_{l} , {π}_{l} )} ( {C}_{l}^{U} ( {Φ}_{l} , {π}_{l} ) - Δ {C}_{( - l )}^{U} ( {Φ}_{l} ) ) \\ {C}_{\text{?}}^{\text{?}} ( {Φ}_{l} , {π}_{l} ) = {\sum }_{\text{?}} {μlog}_{2} ( 1 + \frac{{β}_{\text{?}}^{2}}{{\sum }_{\text{?}} {β}_{\text{?}}^{2}} ) \\ Δ {C}_{( - l )}^{U} ( {Φ}_{l} ) = {\sum }_{\text{?}} {\sum }_{\text{?}} {μlog}_{2} ( \frac{1 + \frac{{β}_{\text{?}}^{2}}{{\sum }_{\text{?}} {β}_{\text{?}}^{2}}}{1 + \frac{{β}_{\text{?}}^{2}}{{β}_{\text{?}}^{2} {\sum }_{\text{?}} {β}_{\text{?}}^{2}}} ) \\ where \\ \text{?} \text{indicates text missing or illegible when filed} \qquad [ Equation 8 ]$$

Also, base stations of which the type and the number of pilots available to be assigned to the terminal or the type and the number of pilots assigned to the terminal are identical to the type and the number of pilots available to be assigned to the terminal or the type and the number of pilots assigned to the terminal of the base station 110 may exist among the base stations included in the communication system. In this example, the network capacity measurer 210 may create a set of pilots through grouping, with the base station 110, at least one other base station of which a type and a number of pilots available to be assigned to a terminal or a type and a number of pilots assigned to a terminal are identical to the type and the number of pilots available to be assigned to the terminal or the type and the number of pilots assigned to the terminal of the base station 110. Additionally, the network capacity measurer 210 may calculate the network capacity of the cell of the base station 110, and transmit the calculated network capacity of the cell to the at least one other base station included in the set of pilots. Further, the network capacity measurer 210 may receive the network capacity of the cell from the at least one other base station included in the set of pilots, and set the received network capacity of the cell to be the network capacity of the cell of the base station 110. For example, the network capacity measurer 210 may calculate Ψₗ^{opt} and πₗ^{opt} for maximizing the network capacity of the cell of the at least one other base station included in the set of pilots using Equation 9.

$$( {Φ}_{l}^{opt , U} , {π}_{l}^{opt , U} ) = arg {max}_{( {Ψ}_{l} , {π}_{l} ) ∈ {Ω}_{l}^{U}} ( {C}_{l}^{U} ( {Φ}_{l} , {π}_{l} ) - Δ {C}_{( - l )}^{U} ( {Φ}_{l} ) ) \qquad [ Equation 9 ]$$

In particular, the number of base stations of which the network capacity is to be calculated may be reduced by calculating the network capacity of the cell of the at least one other base station included in the set of pilots, and calculating the calculated network capacity of the cell to be the common network capacity of the at least one other base stations included in the set of pilots. Also, as the number of base stations of which the network capacity is to be calculated decreases, the amount of calculation required for selecting Ψₗ^{opt} and πₗ^{opt} for maximizing the total of the network capacity of the communication system may decrease.

FIG. 3 is a diagram illustrating a terminal selector 220 according to an embodiment of the present invention.

Referring to FIG. 3, the terminal selector 220 may include a transmission capacity measurer 310 and an optimum terminal selector 320.

The transmission capacity measurer 310 may measure a transmission capacity between the plurality of terminals 120 and the base station 110 disposed in the cell 111 when the number of the plurality of terminals 120 disposed in the cell 111 of the base station 110 is greater than the number of terminals to be supported by the base station 110.

More particularly, the transmission capacity measurer 310 may calculate a signal-to-interference ratio (SIR) of a channel through measuring a channel between the base station 110 and the plurality of terminals 120. In a subsequent step, the transmission capacity measurer 310 may predict the transmission capacity between the plurality of terminals 120 and the base station 110, using the SIR of the channel.

The optimum terminal selector 320 may select at least one terminal for maximizing a network capacity from among the plurality of terminals 120 disposed in the cell 111, based on the transmission capacity between the plurality of terminals 120 and the base station 110 and the number of terminals to be supported by the base station 110.

More particularly, the optimum terminal selector 320 may align the plurality of terminals 120 disposed in the cell 111 based on the transmission capacity, and in a sequential order, select a number of terminals corresponding to the number of terminals to be supported by the base station 110. For example, when a first terminal of which the transmission capacity is 5, a second terminal of which the transmission capacity is 6, and a third terminal of which the transmission capacity is 9 exist, and when the number of terminals to be supported by the base station 110 is 2, the optimum terminal selector 320 may select the third terminal of which the transmission capacity is the largest, and the second terminal of which the transmission capacity is the second largest.

FIG. 4 is a diagram illustrating a process of selecting a terminal according to an embodiment of the present invention.

A terminal t1, a terminal t2, a terminal t3, a terminal t4, and a terminal t5 may be disposed in a cell 401 of a base station 400, and a number of terminals to be supported by the base station 400 may correspond to 4.

In this example, the transmission capacity measurer 310 of the communication apparatus 200 may measure a transmission capacity between the terminal t1, the terminal t2, the terminal t3, the terminal t4, and the terminal t5 and the base station 400. For example, the transmission capacity measurer 310 may measure the transmission capacity of the terminal t1 to be 8, the transmission capacity of the terminal t2 to be 7, the transmission capacity of the terminal t3 to be 1, the transmission capacity of the terminal t4 to be 6, and the transmission capacity of the terminal t5 to be 9.

The optimum terminal selector 320 of the communication apparatus 200 may select four terminals 410, based on the transmission capacities of the terminal t1, the terminal t2, the terminal t3, the terminal t4, and the terminal t5. Here, when an antenna is added to the base station 400 and the number of terminals to be supported by the base station 400 increases, the optimum terminal selector 320 may select a greater number of terminals based on the increased number of terminals.

Also, a terminal of which the transmission capacity is least may be the terminal t3 from among the terminal t1, the terminal t2, the terminal t3, the terminal t4, and the terminal t5. Accordingly, the optimum terminal selector 320 may select the terminal t1, the terminal t2, the terminal t4, and the terminal t5 of which the transmission capacities are greater than the transmission capacity of the t3 420 to be the four terminals 410 as shown in FIG. 4.

In this instance, the terminal t3 420 may not communicate with the base station 400 until one of the four terminals 410 fails to communicate because the terminal t3 420 is not selected.

FIG. 5 is a diagram illustrating a pilot selector 230 according to an embodiment of the present invention.

Referring to FIG. 5, when the number of the plurality of terminals 120 disposed in the cell 111 is less than the number of the plurality of terminals 120 to be supported by the base station 110, a pilot unused for communication with the plurality of terminals 120 may be created from among pilots of the base station 110.

The pilot selector 230 may select a pilot identical to a pilot used by a neighboring base station to be the pilot unused for communication, and minimize interference with the neighboring base station.

Referring to FIG. 5, the pilot selector 230 may include a pilot identifier 510 and an optimum pilot selector 520.

The pilot identifier 510 may identify a pilot assigned to a terminal disposed, by a neighboring base station, in a cell of the neighboring base station when the number of the plurality of terminals 120 disposed in the cell 111 of the base station 110 is less than the number of terminals to be supported by the base station 110.

In this example, the pilot identifier 510 may receive, from the neighboring base station, information associated with the pilot assigned to the terminal disposed in the cell of the neighboring base station.

The optimum pilot selector 520 may select a pilot differing from the pilot identified by the pilot identifier 510 from among the pilots of the base station 110, and assign the selected pilot to the terminal disposed in the cell 111.

Also, the optimum pilot selector 520 may transmit, to neighboring base stations, information associated with pilots assigned to terminals. In this instance, the neighboring base stations may select a pilot to be assigned to terminals disposed in cells of the neighboring base stations based on the received information.

FIG. 6 is a diagram illustrating a process of selecting a pilot according to an embodiment of the present invention.

Referring to FIG. 6, a terminal t1 612 and a terminal t2 613 may be disposed in a cell 611 of a base station 610, a terminal t3 and a terminal t4 623 may be disposed in a cell 621 of a neighboring base station 620 in vicinity of the base station 610, and the base station 610 and the neighboring base station 620 may use a pilot p1, a pilot p2, a pilot p3, and a pilot p4.

In this example, the pilot identifier 510 of the communication apparatus 200 may identify that the pilot p3 is assigned to the terminal t3 622, and the pilot p4 is assigned to the terminal t4 623 both by the neighboring base station 620.

The optimum pilot selector 520 of the communication apparatus 200 may select pilots remaining subsequent to excluding the pilot p3 and the pilot p4 being used by the neighboring base station 620 from among the pilot p1, the pilot p2, the pilot p3, and the pilot p4 available to be used by the base station 610 to be pilots to be assigned to the terminal t1 612 and the terminal t2 613. The optimum pilot selector 520 may enable neighboring base stations to communicate with terminals through use of differing pilots by assigning the pilot p1 and the pilot p2 unused by the neighboring base station 620 to the terminal t1 612 and the terminal t2 613, respectively.

In particular, the communication apparatus 200 may enable the base station to communicate with the terminals through use of the pilots differing from the pilots of the neighboring base stations, thereby minimizing the inter-cell interference, and increasing the total of the network capacity of the communication system.

FIG. 7 is a diagram illustrating a pilot assigner 240 according to an embodiment of the present invention.

When a difference between the number of the plurality of terminals 120 disposed in the cell 111 and the number of the plurality of terminals 120 to be supported by the base station 110 is less than the number of pilots used by the neighboring base station, the base station 110 may use a portion or a total of the pilots used by the neighboring base station for communication with the terminal.

The pilot selector 230 may use a pilot identical to a pilot assigned, by the neighboring base station, to a terminal disposed in an area of the cell of the neighboring base station adjacent to the base station for communication with a terminal disposed in an area of the cell of the base station remote from the neighboring base station, thereby minimizing interference between the terminals to which the identical pilots are assigned. Also, the pilot selector 230 may use a pilot differing from the pilot assigned to the terminal disposed, by the neighboring base station, in the area of the cell of the neighboring base station adjacent to the base station for communicating with a terminal disposed in an area of the cell of the base station adjacent to the neighboring base station, thereby minimizing the interference between the terminals to which the identical pilots are assigned.

Referring to FIG. 7, the pilot assigner 240 may include a pilot identifier 710 and an optimum pilot assigner 720.

The pilot identifier 710 may identify a pilot assigned to an interfering terminal which interferes with the terminal disposed in the cell of the base station, from among the terminals disposed in the cell of the neighboring base station.

More particularly, the pilot identifier 710 may determine a terminal of which a distance from the cell of the base station is less than a predetermined distance to be the interfering terminal, from among the terminals disposed in the cell of the neighboring base station, and identify the pilot assigned, by the neighboring base station, to the interfering terminal. In this instance, the neighboring base station may receive, from the neighboring base station, information associated with the pilot assigned, by the neighboring base station, to interfering terminals.

The optimum pilot assigner 720 may assign a pilot to the terminal disposed within a predetermined distance from the interfering terminal, from among the terminals disposed in the cell of the base station based on the identifier pilot.

More particularly, the optimum pilot assigner 720 may determine the terminal of which the distance from the cell of the neighboring base station is less than a predetermined distance to be the terminal disposed within a predetermined distance from the interfering terminal, from among the terminals disposed in the cell of the base station. Also, pilots differing from pilots of the interfering terminal may be assigned to the terminal disposed within the predetermined distance from the interfering terminal.

For example, when the pilot p3 is assigned to the interfering terminal, the optimum pilot assigner 720 may assign another pilot, other than the pilot p3, to the terminal disposed within the predetermined distance from the interfering terminal, and prevent an occurrence of interference with the interfering terminal.

Also, the optimum pilot assigner 720 may transmit, to the neighboring base station, information associated with the pilots assigned to the terminals. In this instance, the neighboring base stations may assign a pilot to the terminals disposed in the cell of the neighboring base station based on the received information.

FIG. 8 is a diagram illustrating a process of assigning a pilot according to an embodiment of the present invention.

Referring to FIG. 8, a terminal t1 812, a terminal t2 813, a terminal t3 814, and a terminal t4 815 may be disposed in a cell 811 of a base station 810, and a terminal t5 822, a terminal t6 823, a terminal t7 824, and a terminal t8 825 may be disposed in a cell 821 of a neighboring base station 820. In particular, the base station 810 and the neighboring base station 820 may use a pilot p1, a pilot p2, a pilot p3, and a pilot p4. Also, the terminal t1 812 and the terminal t2 813 may be adjacent to the cell 821, and the terminal t5 822 and the terminal t6 823 may be adjacent to the cell 811.

Here, the pilot identifier 710 of the communication apparatus 200 may determine the terminal t5 822 and the terminal t6 823 adjacent to the cell 811 to be an interfering terminal, and identify that the pilot p3 is assigned to the terminal t5 822 by the base station 820, and the pilot t4 is assigned to the terminal t6 823 by the base station 820.

The optimum pilot selector 520 of the communication apparatus 200 may assign the pilot p3 and the pilot p4 being used by the interfering terminals, for example, the terminal t5 822 and the terminal t6 823, to the terminal t3 814 and the terminal t4 815 disposed in an opposite direction to the neighboring base station 821, from among the pilot p1, the pilot p2, the pilot p3, and the pilot p4 available to be used by the base station 810. Additionally, the optimum pilot selector 520 may assign the pilots, for example, the pilot p1 and the pilot p2, differing from the pilot used by the interfering terminal to the terminal t1 812 and the terminal t2 813 adjacent to the cell 821.

In particular, the communication apparatus 200 may assign differing pilots to the terminal t1 812, the terminal t2 813, the terminal t5 822, and the terminal t6 823, respectively, amongst which interference may occur due to a close distance with one another, and increase a total of a network capacity of a communication system through minimizing the inter-cell interference.

FIG. 9 is a diagram illustrating a process of assigning a number of pilot symbols according to an embodiment of the present invention.

A terminal t1 and a terminal t2 may be disposed in a cell 911 of a base station 910, and a terminal t3, a terminal t4, a terminal t5, and a terminal t6 may be disposed in a cell 921 of a neighboring base station 920. Also, a number of terminals to be supported by the base station 910 and the base station 920 may be 4.

In this instance, the pilot symbol number assigner 250 of the communication apparatus 200 may select a maximum number of pilot symbols of the cell 911 to be integer multiples of a least Nₛₘₒₒₜₕ greater than a number terminals disposed in the cell 911, for example, 2. Here, Nₛₘₒₒₜₕ denotes an orthogonal subcarrier in a coherence bandwidth (BW). In particular, a relationship amongst the coherence BW, a maximum number K of pilot symbols of a base station within a coherence time, a maximum number D of data symbols, and a total number T of symbols of the base station may be defined by Equation 10.

K=τNₛₘₒₒₜₕ

D=(J−τ)Nₛₘₒₒₜₕ

T=JNₛₘₒₒₜₕ

Also, the pilot symbol number assigner 250 of the communication apparatus 200 may select a maximum number of pilot symbols of the cell 921 to be multiple integers of a least Nₛₘₒₒₜₕ greater than a number of terminals disposed in the cell 921, for example, 4.

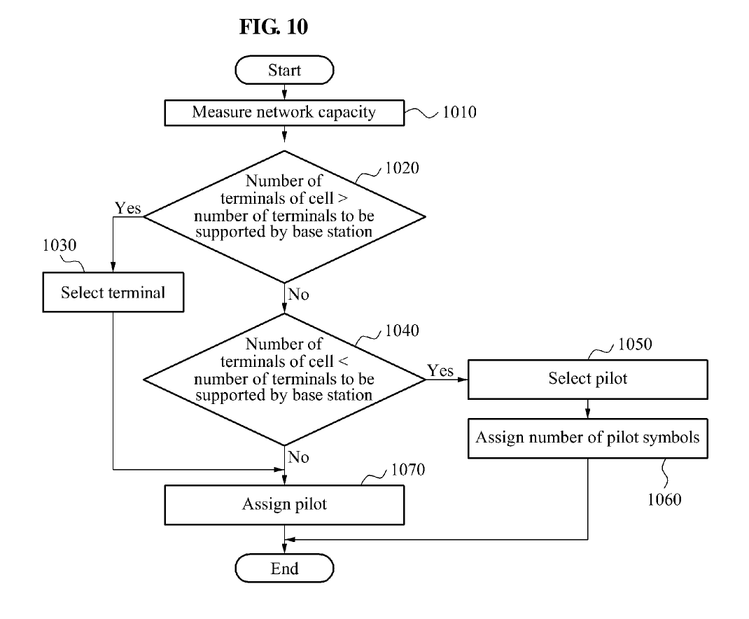

FIG. 10 is a flowchart illustrating a method of operating a base station according to an embodiment of the present invention.

In operation 1010, the network capacity measurer 210 may calculate a network capacity of a communication system, using information associated with a terminal and a pilot selected by base stations included in the communication system and a pilot assigned by the base stations to a terminal is disposed.

In operation 1020, the terminal selector 220 may verify whether the number of the plurality of terminals 120 disposed in the cell 111 is greater than the number of terminals to be supported by the base station 110. In this instance, when the number of the plurality of terminals 120 disposed in the cell 111 is greater than the number of terminals to be supported by the base station 110, the terminal selector 220 may perform operation 1030, when the number of the plurality of terminals 120 disposed in the cell 111 is less than the number of terminals to be supported by the base station 110, the terminal selector 220 may perform operation 1040.

In operation 1030, the terminal selector 220 may select the number of terminals to be supported by the base station 110 based on the transmission capacity of the plurality of terminals 120 when the number of the plurality of terminals 120 disposed in the cell 111 is greater than the number of terminals to be supported by the base station 110.

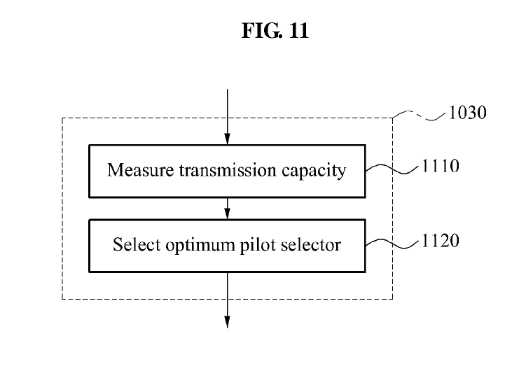

Detailed configurations and operations in which the terminal selector 220 selects the plurality of terminals 120 will be described with reference to FIG. 11.

In operation 1040, the pilot selector 230 may verify whether the number of the plurality of terminals 120 disposed in the cell 111 is less than the number of the plurality of terminals 120 to be supported by the base station 110. In this instance, when the number of the plurality of terminals 120 disposed in the cell 111 is less than the number of terminals to be supported by the base station 110, the pilot selector 230 may perform operation 1050, and when the number of the plurality of terminals 120 disposed in the cell 111 is identical to the number of terminals to be supported by the base station 110, the pilot selector 230 may perform operation 1070.

In operation 1050, when the number of the plurality of terminals 120 disposed in the cell 111 is less than the number of the plurality of terminals 120 to be supported by the base station 110, the pilot selector 230 may identify pilots assigned, by the base station 130 and the base station 140, to terminals disposed in the cells of the base station 130 and the base station 140, respectively, and based on a result of the identification, select a pilot to be assigned to the plurality of terminals 120.

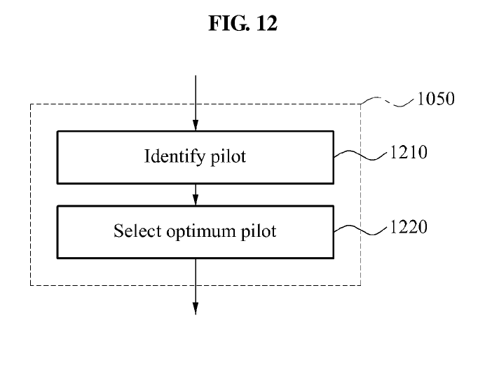

Detailed configurations and operations in which the pilot selector 230 selects the pilot will be described with reference to FIG. 12.

In operation 1060, the pilot symbol number assigner 250 may assign a maximum number of pilot symbols based on the number of terminals disposed in the cell 911 to maximize the network capacity and a personal processing capacity of the cell 911, and use the remaining symbols as a data symbol.

More particularly, when the number of the plurality of terminals 120 disposed in the cell 111 is less than the number of the plurality of terminals 120 to be supported by the base station 110, the pilot symbol number assigner 250 may select the maximum number of pilot symbols of the base station 110 based on the number of the plurality of terminals 120 disposed in the cell 111, and use a number of symbols remaining subsequent to excluding the maximum number of pilot symbols of the base station 110 from the total number of symbols as the number of data symbols of the base station 110.

In operation 1070, the pilot assigner 240 may assign a pilot not to be interfered with by the plurality of terminals 120 likely to experience interference due to a neighboring base station, based on a pilot assigned, by the neighboring base station, to terminals disposed in the respective cells of the neighboring base station. In this instance, the pilot assigner 240 may assign a pilot to a number of terminals corresponding to the number of terminals selected in operation 1030 or the number of terminals to be supported by the base station 110.

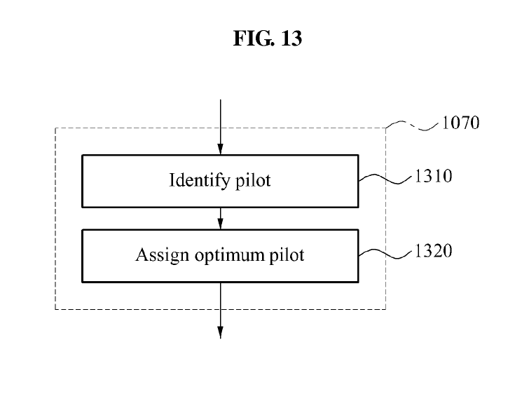

Detailed configurations and operations in which the pilot assigner 240 assigns the pilot will be described with reference to FIG. 13.

FIG. 11 is a flowchart illustrating a method of selecting a terminal according to an embodiment of the present invention. Operations 1110 and 1120 of FIG. 11 may be included in operation 1030 of FIG. 10.

In operation 1110, the transmission capacity measurer 310 may measure the transmission capacity between the plurality of terminals 120 and the base station 110 disposed in the cell 111 when the number of the plurality of terminals 120 disposed in the cell 111 of the base station 110 is greater than the number of terminals to be supported by the base station 110.

More particularly, the transmission capacity measurer 310 may measure the channel between the base station 110 and the plurality of terminals 120, and calculate an SIR. In a subsequent step, the transmission capacity measurer 310 may predict the transmission capacity between the plurality of terminals 120 and the base station 110, using the SIR of the channel.

In operation 1120, the optimum terminal selector 320 may select at least one terminal for maximizing the network capacity from among the plurality of terminals 120 disposed in the cell 111, based on the transmission capacity measured in operation 1110 and the number of terminals to be supported by the base station 110.

More particularly, the optimum terminal selector 320 may align the plurality of terminals 120 disposed in the cell 111 based on the transmission capacity, and select the number of terminals to be supported by the base station 110 in a sequential order.

FIG. 12 is a flowchart illustrating a method of selecting a pilot according to an embodiment of the present invention. Operation 1210 and operation 1220 of FIG. 12 may be included in operation 1050 of FIG. 10.

In operation 1210, when the number of the plurality of terminals 120 disposed in the cell 111 of the base station 110 is less than the number of terminals to be supported by the base station 110, the pilot identifier 510 may identify a pilot assigned, by a neighboring base station, to a terminal disposed in a cell of the base station 110.

In this instance, the pilot identifier 510 may receive, from the neighboring base station, information associated with a pilot assigned, by the neighboring base station, to a terminal disposed in a cell of the neighboring base station.

In operation 1220, the optimum pilot selector 520 may select a pilot differing from the pilot identified in operation 1210 from among the pilots of the base station 110, and assign the selected pilot to the terminal disposed in the cell 111.

Also, the optimum pilot selector 520 may transmit, to the neighboring base station, information associated with pilots assigned to terminals. In this instance, the neighboring base station may select the pilot to be assigned to the terminals disposed in the cell of the neighboring base station based on the received information.

FIG. 13 is a flowchart illustrating a method of assigning a pilot according to an embodiment of the present invention. Operations 1310 and 1320 of FIG. 13 may be included in operation 1070 of FIG. 10.

In operation 1310, the pilot identifier 710 may identify the pilot assigned to an interfering terminal which interferes with the terminal disposed in the cell of the base station, from among the terminals disposed in the cell of the neighboring base station.

More particularly, the pilot identifier 710 may determine a terminal of which a distance from the cell of the base station is less than a predetermined distance to be the interfering terminal from among the terminals disposed in the cell of the neighboring base station, and identify the pilot assigned, by the neighboring base station, to the interfering terminal. In this instance, the pilot identifier 710 may receive, from the neighboring base station, information associated with the pilot assigned, by the neighboring base station, to interfering terminals.

In operation 1320, the optimum pilot assigner 720 may assign a pilot to the terminal disposed within a predetermined distance from the interfering terminal, from among the terminals disposed in the cell of the base station based on the identifier pilot.

More particularly, the optimum pilot assigner 720 may determine the terminal of which the distance from the cell of the neighboring base station is less than the predetermined distance to be the terminal disposed in the predetermined distance from the interfering terminal, from among the terminals disposed in the cell of the base station. Also, the optimum pilot assigner 720 may assign pilots, differing from pilots of the interfering terminal, to the terminal disposed within the predetermined distance from the interfering terminal.

For example, when the pilot p3 is assigned to the interfering terminal, the optimum pilot assigner 720 may assign another pilot except the pilot p3 to the terminal disposed within the predetermined distance from the interfering terminal, and thereby prevent interference with the interfering terminal.

Also, the optimum pilot assigner 720 may transmit, to the neighboring base station, information associated with the pilots assigned to the terminals. In this instance, the neighboring base stations may assign a pilot to the terminals disposed in the cell of the neighboring base station based on the received information.

According to an exemplary embodiment, it is possible to select a number of terminals to be supported by a base station based on a transmission capacity of terminals, and transmit maximum data to terminals for transmitting a maximum data capacity when a number of terminals disposed in a cell of the base station is greater than the number of terminals to be supported by the base station.

According to an exemplary embodiment, it is possible to identify a pilot to be assigned to a terminal disposed, by a neighboring base station, in a cell of the neighboring base station, and identify pilots capable of transmitting maximum data to the terminal in the cell of the base station when a number of terminals disposed in the cell of the base station is less than a number of terminals to be supported by the base station.

According to an exemplary embodiment, it is possible to assign a pilot selected based on a number of users in a cell of a base station to minimize interference in a cell of a neighboring base station, and identify a pilot for transmitting, from a plurality of terminals, maximum data.

According to an exemplary embodiment, it is possible to select a maximum number of pilot symbols based on a number of terminals disposed in a cell, and identify an optimum number of pilot symbols based on a number of terminals when the number of terminals disposed in the cell is less than a number of terminals to be supported by the base station.

According to an exemplary embodiment, it is possible to limit an object for calculating a network capacity to a base station, or a set of pilots using identical pilots, and reduce an amount of calculation required for calculating the network capacity.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A communication method conducted by a communication apparatus of a base station, the communication method comprising:
measuring a transmission capacity between terminals disposed in a cell and a base station when a number of the terminals disposed in the cell of the base station is greater than a number of terminals to be supported by the base station; and
selecting at least one terminal of which a capacity of a network is maximized, from among the terminals disposed in the cell, based on the transmission capacity and the number of terminals to be supported by the base station.

2. The communication method of claim 1, wherein the measuring of the transmission capacity comprises:
measuring a channel between the base station and the terminal, and calculating a signal-to-interference ratio (SIR) of the channel; and
predicting the transmission capacity between the terminal and the base station, using the SIR of the channel.

3. The communication method of claim 1, wherein the capacity of the network is measured based on information associated with a pilot and a terminal selected by base stations of a network system in which a base station is disposed.

4. A communication method conducted by a communication apparatus of a base station, the communication method comprising:
identifying a pilot used by a neighboring base station when a number of terminals disposed in a cell of a base station is less than a number of terminals to be supported by the base station; and
selecting a pilot differing from the pilot used by the neighboring base station from among pilots of the base station, and assigning the selected pilot to the terminals disposed in the cell of the base station.

5. The communication method of claim 4, wherein the assigning of the selected pilot to the terminals comprises:
selecting a pilot of which a capacity of a network system measured based on information associated with a pilot and a terminal selected by base stations of a network system in which the base stations are disposed.

6. A communication method conducted by a communication apparatus of a base station, the communication method comprising:
identifying a pilot assigned to an interfering terminal which interferes with a terminal disposed in a cell of a base station, from among terminals disposed in a cell of a neighboring base station; and
assigning a pilot to a terminal disposed within a predetermined distance from the interfering terminal, from among the terminals disposed in the cell of the base station based on the identified pilot.

7. The communication method of claim 6, wherein the assigning of the pilot comprises:
assigning a pilot differing from the pilot identified, from among pilots of the base stations, to the terminal disposed within the predetermined distance from the interfering terminal.

8. The communication method of claim 6, wherein the assigning of the pilot comprises:
assigning, to the terminal, a pilot of which a capacity of a network system measured based on information associated with a pilot and a terminal selected by base stations of a network system in which the base stations are disposed.

9. A communication method conducted by a communication apparatus of a base station, the communication method comprising:
selecting a maximum number of pilot symbols of a base station, based on a number of terminals disposed in a cell of the base station when a number of the terminals disposed in the cell of the base station is less than a number of terminals to be supported by the base station.

10. The communication method of claim 9, further comprising:
using a number of symbols, subsequent to excluding the maximum number of pilot symbols of the base station from a total number of symbols of the base station.

11. A communication apparatus, comprising:
a capacity measurer to measure a capacity of a network system, based on information associated with a terminal connected to a base station of the network system, and a pilot to be assigned, by the base station, to the terminal; and
a terminal selector to select a terminal for transmitting data, by the base station, to maximize the capacity of the network system.

12. The communication apparatus of claim 11, wherein the capacity measurer calculates the capacity of the network system of the base station, based on the information associated with the terminal connected to the base station of the network system and the pilot to be assigned, by the base station, to the terminal, and
the terminal selector selects a terminal to which the data is transmitted by the base station to maximize the capacity of the network system of the base station.

13. The communication apparatus of claim 11, wherein the terminal selector comprises:
a transmission capacity measurer to measure a transmission capacity between terminals disposed in a cell and a base station when a number of the terminals disposed in the cell of the base station is greater than a number of terminals to be supported by the base station; and
an optimum terminal selector to select at least one terminal of which a capacity of a network system is maximized, from among the terminals disposed in the cell, based on the transmission capacity and the number of terminals to be supported by the base station.

14. A communication apparatus, comprising:
a capacity measurer to measure a capacity of a network system based on information associated with a terminal connected to a base station of the network system and a pilot to be assigned, by the base station, to the terminal; and
a pilot selector to select the pilot to be assigned, by the base station, to the terminal, to maximize the capacity of the network system.

15. The communication apparatus of claim 11, wherein the pilot selector comprises:
a pilot identifier to identify a pilot used by a neighboring base station when a number of terminals disposed in a cell of the base station is less than a number of terminals to be supported by the base station; and
an optimum pilot selector to select a pilot differing from the pilot used by the neighboring base station from among pilots of the base station, and maximize the capacity of the network system.

16. A communication apparatus, comprising:
a capacity measurer to measure a capacity of a network system based on information associated with a terminal connected to a base station of the network system and a pilot to be assigned, by the base station, to the terminal; and
a pilot assigner to assign a pilot to a terminal to maximize the capacity of the network system.

17. The communication apparatus of claim 16, wherein the pilot assigner comprises:
a pilot identifier to identify a pilot assigned to an interfering terminal which interferes with a terminal disposed in a cell of a base station, from among terminals disposed in a cell of a neighboring base station; and
an optimum pilot assigner to assign a pilot to a terminal disposed within a predetermined distance from the interfering terminal, from among the terminals disposed in the cell of the base station, based on the identified pilot, and maximize the capacity of the network system.

18. The communication apparatus of claim 17, wherein the optimum pilot assigner assigns a pilot differing from the identified pilot, from among the pilots of the base station, to the terminal disposed within the predetermined distance from the interfering terminal.

19. A communication apparatus, comprising:
a pilot symbol number assigner to select a maximum number of pilot symbols of a base station, based on a number of terminals disposed in a cell of the base station when the number of the terminals disposed in the cell of the base station is less than a number of terminals to be supported by the base station.

20. The communication apparatus of claim 19, wherein the pilot symbol number assigner uses a number of symbols subsequent to excluding the maximum number of pilot symbols of the base station, from a total number of symbols of the base station, as a number of data symbols of the base station.
